(19) United States
(12) Patent Application Publication
(10) Pub. No.: US 2026/0266265 A1
(43) Pub. Date: Sep. 10, 2026

(54) DEVICE FOR WIND TURBINE BLADE AND TOWER MAINTENANCE AND A SYSTEM FOR RAISING AND LOWERING THE DEVICE

(71) Applicant: AERONES AMERICA LLC, San Jose, CA (US)

(72) Inventor: Jãnis PUTRÄMS, Rïga (LV)

(73) Assignee: AERONES AMERICA LLC, San Jose, CA (US)

(21) Appl. No.: 19/633,839

(22) Filed: Mar. 30, 2026

Related U.S. Application Data
(63) Continuation of application No. 17/629,974, filed on Jul. 26, 2019, now Pat. No. 12,612,899.

(51) Int. Cl. F03D 80/55; F03D 1/06; F03D 80/50

(52) U.S. Cl. CPC F03D 80/55; F03D 1/0675; F03D 80/50; F05B 2230/80

(57) ABSTRACT

A wind turbine blade and tower maintenance device, used for servicing, including cleaning, inspection, deicing and painting of wind turbine blades and tower. The device has: a plurality of balancing rods, a central hub, at least one tool arm adapted to releasably fix one or more tools adapted for surface maintenance; and a tool arm motor adapted to adjust the angle of the tool arm in respect a longitudinal axis of the central hub, wherein: the central rod and balancing rods are connected to the central hub; the tool arm is rotatably fixed to the central hub and the balancing rods and central hub are adapted to be connected to carrying and balancing ropes or cables. A system for lowering and raising of the arrangement is also disclosed.

### TECHNICAL FIELD

The invention relates to wind turbine blade and tower maintenance devices, used for servicing, including cleaning, inspection, deicing and painting of wind turbine blades and tower.

### BACKGROUND ART

In the course of use wind turbine blades require constant maintenance. Bird strikes, lightning strikes, leading edge and surface erosion cause damage to wind turbine blades. Damaged, faulty, dirty, or covered by ice wind turbine blades can reduce overall productivity of the wind turbine.

Traditionally, blade inspection and maintenance are made by industrial climbers, who use rope and cradle access to get to the blade. More comfortable workspace can ensure use of a platform travelling along the wind turbine. However, safer, less expensive and less time-consuming solutions for wind turbine blade maintenance use robots or arrangements, which do not require presence of workers at heights.

There is known a work platform for use on a blade of a wind turbine (U.S. Pat. No. 9,624,901 B2). The work platform is provided with space for a technician and is preferably adapted for positioning along a leading or trailing edge of a wing blade, and is further comprising at least two projecting arms for contact against the surface of the blade.

There is known blade maintenance device for wind turbine (EP 2752621 B1) comprising a body adapted to travel along a leading edge of a wind turbine blade, support arms with rollers, which extend from the body to both sides of the blade; and a maintenance unit installed at the body; the maintenance unit comprising cleaning robot arms installed at both sides of the body and a cleaning brush installed at a distal end of each of the arms.

There is known a wind turbine rotor blade cleaner (WO 2011107087), comprising a U-shaped carrier with two legs, each of which is provided with rotating brush. The carrier is adapted to be placed on the front edge of a rotor blade, wherein free ends of the legs point toward the tip of the profile of the rotor blade and are arranged on the two sides of the rotor blade lying opposite each other.

There is known an apparatus for cleaning of oblong objects (EP 1517033 B1), comprising two spaced apart substantially cylindrical brush devices, being rotatable about their longitudinal axis. Each brush device is attached at least in one end to an intermediate frame, wherein the attachment comprises a hinge means allowing the brush device to pivot in a first plane, and pivot control means comprising an actuator in such a manner that the relative angle between the longitudinal axis of the two brush devices may be adjusted, and that the distance between the two brush devices may be adjusted by sliding movement initiated by a second actuator means attached to the intermediate frame, and that said intermediate frame is attached to a main frame, said main frame comprising means for being attached to a lifting means.

There is known a wind turbine blade treatment apparatus (U.S. Pat. No. 8,544,484 B2), comprising a support having a frame with an edge follower configured to be positioned near an edge of a wind turbine blade. The support further comprising a side member connected to the frame and configured to extend at least partially along a width of the wind turbine blade and to be positioned near the wind turbine blade. The wind turbine blade treatment apparatus further comprises a sprayer connected to the support, configured to spray fluid onto the wind turbine blade.

Although the prior art solutions partially solve the problem of efficient surface treating, their efficiency is still insufficient.

### SUMMARY OF INVENTION

The invention provides an arrangement for wind turbine blade and tower maintenance as well as system for lowering and raising the arrangement. The arrangement comprising: a central rod, three balancing rods, a central hub, at least one tool arm adapted to releasably fix one or more tools aimed for surface maintenance; and a tool arm motor adapted to adjust the angle of the tool arm in respect of the central rod. The central rod and three balancing rods are connected to the central hub. The tool arm is rotatably fixed to the central rod and/or to the central hub via tool arm motor drive. The three balancing rods, as well as central rod or the central hub are adapted to be connected to carrying and balancing ropes or cables.

According to the preferred embodiment the arrangement further comprises a rail with a slider and a motor connected to a lead screw, wherein the rail is fixed to the upper end of the central rod, with the slider located on the rail and connected to the motor drive via the lead screw, so that to allow controllable sliding motion of the slider along the rail. The slider, preferably, further comprises a guide designed to allow a carrying rope passing through it with minimal friction. According to the preferable embodiment the hinges are fixed to the central hub and the balancing rods, so to allow at least limited rotation of the balancing rods in the vertical plane. According to yet another embodiment the arrangement further comprises arms, optionally having rotatable wheels; where each of the arms is further provided with a linear actuator fixed to the arm and the central rod; thereby the arms are adapted to position the arrangement for wind turbine blade and maintenance in respect of the wind turbine blade or tower. The optional wheels are designed to be rested upon the surface of the wind turbine blade and allow decreasing friction when moving the arrangement along the surface to be treated. According to yet another embodiment the arrangement further comprises a central rod motor, which is connected to the central rod via the motor drive, allowing controllable rotation of the central rod around its longitudinal axis.

### BRIEF DESCRIPTION OF DRAWINGS

FIG. 1—shows a perspective view of the arrangement;

FIG. 2—top view of the arrangement;

FIG. 3—a schematic view of the arrangement in operation according to one embodiment

### DETAILED DESCRIPTION OF INVENTION

The proposed arrangement for wind turbine blade and tower maintenance, comprises a central rod 1, three balancing rods 2, a central hub 7, at least one tool arm 12 adapted to releasably fix one or more tools aimed for surface maintenance; and a tool arm motor 13 (e.g. linear servo motor or a rotating motor) adapted to adjust the angle of the tool arm 12 in respect of the central rod 1, wherein the central rod 1 and three balancing rods 2 are connected to the central hub 7; the tool arm 12 is rotatably fixed to the central rod 1 and/or to the central hub 7 via tool arm 20 motor 13 drive; the three balancing rods 2, as well as central rod 1 or the central hub 7 are adapted to be connected to carrying and balancing ropes or cables. The arrangement may contain further optional elements.

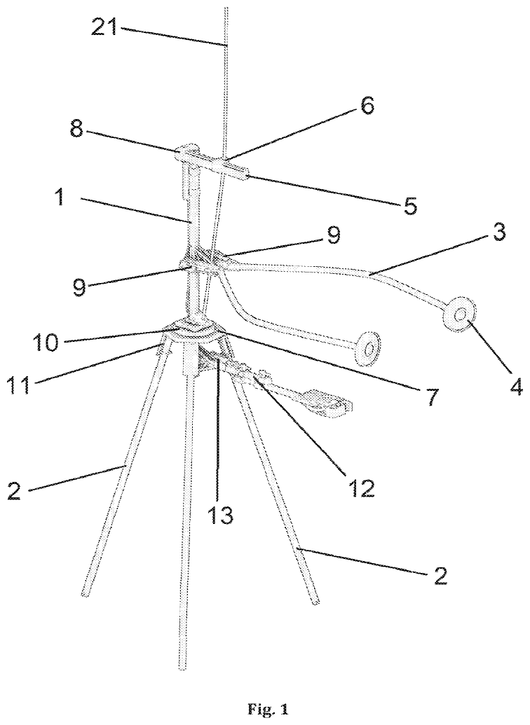

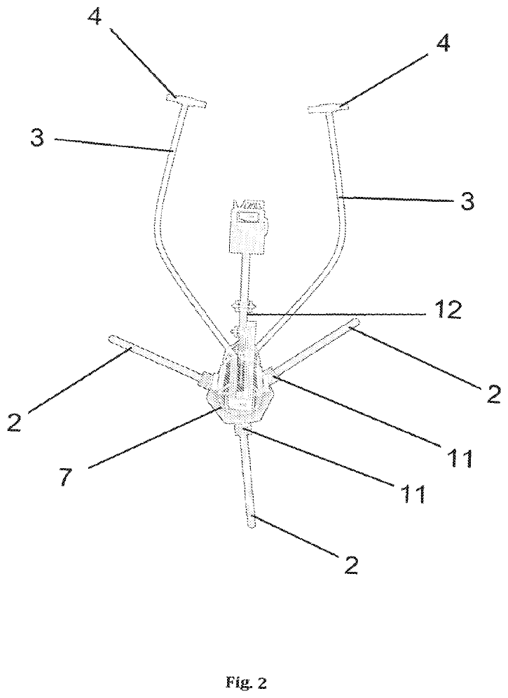

According to the preferred embodiment the arrangement (FIG. 1-2), comprising: a central rod 1; three balancing rods 2; arms 3, having wheels 4; a rail 5; a slider 6 adapted to slide along the rail 5 and having guide designed to allow a rope passing through it with minimal friction; a central hub 7; a motor 8 with lead screw allowing to controllably move the slider 6 along the rail 5 for rope position adjustment along the rail 5; two linear actuators 9 adapted to position arms 3; a motor 10 adapted for rotation of the central rod 1 around its longitudinal axis; hinges 11 adapted to allow the balancing rods 2 to rotate in the vertical plane; at least one tool arm 12 adapted to releasably fix one or more tools aimed for surface maintenance; a tool arm motor 13 adapted to adjust the angle of the tool arm 12 in respect of the central rod 1.

The arms 3 are optional for some maintenance works. For leading edge repair, they are needed to stop wind turbine blade swinging relative to the arrangement.

According to another embodiment, lower end of the central rod 1 is rotatably fixed to the central hub 7 via the motor 10 drive, allowing controllable rotation of the central rod 1 around its longitudinal axis. The rail 5 is fixed to the upper end of the central rod 1. The slider 6 is located on the rail 5 and is connected to the motor 8 drive via the lead screw, so that to allow controllable sliding motion of the slider 6 along the rail 5.

The tool arm 12 is designed to releasably fix a tool intended for processing of a surface. This tool may be inspection or testing head, cleaning head with rotatable brushes and high-pressure nozzle, painting head, crack stitching head and other. A standardized connection is preferably made between the arms and every tool.

According to the preferred embodiment the device further comprises an electronic control unit

It is obvious for the skilled person that said motors and linear actuators may be replaced by manual operation designs.

A carrying rope or cable 20 is connected to the central hub 7 or central rod 1 and, preferably, is put through the slider's 6 guide, which is designed to allow a carrying rope passing through it with minimal friction. Each balancing rope or cable 21 is connected to the respective balancing rod 2. The balancing rods 2 connected to the balancing ropes 21 ensure that the central rod 1 does not rotate when lateral force is applied to the arrangement.

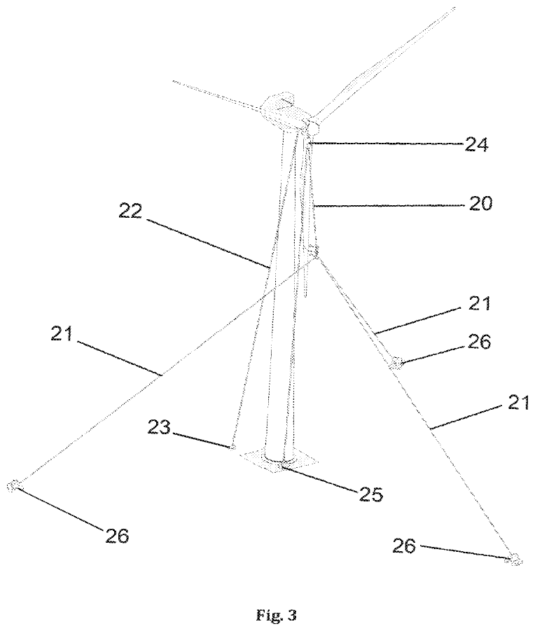

As it is shown in FIG. 3 during maintenance of a wind turbine blade, a carrying rope 20 is attached to the central rod 1 of the arrangement. The balancing ropes 21 are attached to the balancing rods 2.

According to the preferred embodiment the arrangement for wind turbine blade and tower maintenance is used together with a system of ropes, winches and a pulley or a block. The said system comprising: a main rope 22 having ends one and two; a main rope winch or an anchor 23; a pulley or a block 24; the carrying rope 20 having end one and two; a carrying rope winch 25; three balancing ropes 21, each having ends one and two and balancing means 26. The balancing means 26 can be in the form of anchored winches or movable winches. According to one embodiment the balancing means 26 comprise all-terrain vehicles (ATV) with winches installed thereon. End one of the main rope 22 is operably connected to the winch or anchor 23. End two of the main rope 22 is connected to the pulley or block 24, which is hung over the wind turbine blade as shown on FIG. 3. The carrying rope 20 is operably put through the pulley or block 24. End one of the carrying rope 20 is operably connected to the carrying rope winch 25. The end two of the carrying rope 20 is connected to the central rod 1 of the arrangement. Ends one of the balancing ropes 21 are connected to the balancing rods 2. Ends two of the balancing ropes 21 are connected to the balancing means 26. The main rope winch or anchor 23 and/or the carrying rope winch 25 may be placed on a truck trailer.

The system operates as follows. End one of the main rope 22 with the pulley or block 24 is hung over the wind turbine blade. The height of position of the pulley 24 is adjusted as necessary by winding end two of the rope 22. The height of position of the arrangement for wind turbine blade and tower maintenance is adjusted as necessary by winding end one of the carrying rope 20. The stabilization, balance and prevention of rotation of the arrangement is provided by controlling the length and, optionally, the direction of the balancing ropes 21 by winding ends two of the balancing ropes 21 and/or changing location of the balancing means 26.

When work on one blade is finished the arrangement for wind turbine blade and tower maintenance is positioned close to the tower and turbine blades are rotated by about 120 degrees to position the next blade towards ground. When work is finished, the arrangement and the pulley 24, which is directly above it is lowered to the ground, arrangement is disconnected (a dempher is attached instead).

1-10. (canceled)

11. Apparatus for wind turbine blade and tower maintenance comprising:
a central hub;
a plurality of balancing rods connected to the central hub, each one of the plurality of balancing rods extending radially outward and at an angle downward from the central hub and adapted to be coupled to a respective first end of a balancing rope or cable to stabilize the apparatus;
a carrying rope or cable having a first end operatively coupled to the central hub, the carrying rope or cable configured to raise or lower the apparatus relative to a wind turbine blade; and
at least one tool arm extending downward from the central hub and having a tool arm motor and a connector adapted to releasably fix a tool to the tool arm, the tool arm motor adapted to adjust an angle of the tool arm relative to a longitudinal axis of the central hub,
wherein the tool is selected from amongst an inspection or testing head, a cleaning head, a high-pressure nozzle, a painting head, or a crack stitching head.

12. The apparatus of claim 11, further comprising:
an arm having a rotatable wheel configures to be coupled to the central hub; and
a linear actuator fixed to the arm, the linear actuator adapted to position the apparatus relative to a surface of the wind turbine blade, wherein the rotatable wheel is configured to rest upon the surface.

13. The apparatus of claim 11, further comprising a central rod affixed to the central hub, a rail, a slider, and a lead screw motor connected to a lead screw, wherein the rail is fixed to an end of the central rod, and the slider is located on the rail and connected to the lead screw motor via the lead screw.

14. The apparatus of claim 13, wherein the slider further comprises a guide designed to allow the carrying rope or cable to pass through the slider to couple to the central rod.

15. The apparatus of claim 11, further comprising a central hub motor coupled the central rod to the central hub, wherein the central hub motor allows controllable rotation of the central rod around its longitudinal axis.

16. The apparatus of claim 11, further comprising hinges disposed between respective ones of the plurality of balancing rods and the central hub, the hinges configured to rotation of the balancing rods in a vertical plane.

17. The apparatus of claim 11, further comprising an electronic control unit configured to control operation of the apparatus.

18. The apparatus of claim 11, further comprising:
a main rope having a first end coupled to a pulley or block and a second end coupled to a main rope winch or an anchor,
wherein a second end of the carrying rope or cable passes through the pulley or block and is operably connected to a carrying rope or cable winch.

19. The apparatus of claim 18, wherein the carrying rope or cable winch is affixed to a truck trailer.

20. The apparatus of claim 11, wherein respective second ends of the balancing ropes or cables are adapted to be connected an anchored winch or a movable winch.

21. The apparatus of claim 20, wherein each movable winch is affixed to an all-terrain vehicle.

22. Apparatus for wind turbine blade and tower maintenance comprising:
a central hub;
a plurality of balancing rods connected to the central hub, each one of the plurality of balancing rods extending radially outward and at an angle downward from the central hub and adapted to be coupled to a respective first end of a balancing rope or cable to stabilize the apparatus;
a carrying rope or cable having a first end operatively coupled to the central hub, the carrying rope or cable configured to raise or lower the apparatus relative to a wind turbine blade;
a first arm operatively coupled to the central hub, the first arm configured to maintain the apparatus relative to a surface of the wind turbine blade; and
at least one tool arm extending downward from the central hub and having a tool arm motor and a connector adapted to releasably fix a tool to the tool arm, the tool arm motor adapted to adjust an angle of the tool arm relative to a longitudinal axis of the central hub,
wherein the tool is selected from amongst an inspection or testing head, a cleaning head, a high-pressure nozzle, a painting head, or a crack stitching head.

23. The apparatus of claim 22, further comprising a second arm, wherein each of the first arm and the second arm includes a rotatable wheel configured to rest upon a surface of the wind blade turbine.

24. The apparatus of claim 22, further comprising a central rod affixed to the central hub, a rail, a slider, and a lead screw motor connected to a lead screw, wherein the rail is fixed to an end of the central rod, and the slider is located on the rail and connected to the lead screw motor via the lead screw.

25. The apparatus of claim 24, wherein the slider further comprises a guide designed to allow the carrying rope or cable to pass through the slider to couple to the central rod.

26. The apparatus of claim 22, further comprising a central hub motor coupled the central rod to the central hub, wherein the central hub motor allows controllable rotation of the central rod around its longitudinal axis.

27. The apparatus of claim 22, further comprising hinges disposed between respective ones of the plurality of balancing rods and the central hub, the hinges configured to rotation of the balancing rods in a vertical plane.

28. The apparatus of claim 22, further comprising an electronic control unit configured to control operation of the apparatus.

29. The apparatus of claim 22, further comprising:
a main rope having a first end coupled to a pulley or block and a second end coupled to a main rope winch or an anchor,
wherein a second end of the carrying rope or cable passes through the pulley or block and is operably connected to a carrying rope or cable winch.

30. The apparatus of claim 29, wherein the carrying rope or cable winch is affixed to a truck trailer.

31. The apparatus of claim 22, wherein respective second ends of the balancing ropes or cables are adapted to be connected an anchored winch or a movable winch.
